(19) United States
(12) Patent Application Publication
(10) Pub. No.: US 2024/0152765 A1
(43) Pub. Date: May 9, 2024

(54) TRAINING TIME AND RESOURCE CONSUMPTION PREDICTION IN DEEP LEARNING

(71) Applicant: KOREA UNIVERSITY RESEARCH AND BUSINESS FOUNDATION, Seoul (KR)

(72) Inventors: Gyeongsik YANG, Seoul (KR); Changyong SHIN, Seoul (KR); Yeonho YOO, Seoul (KR); Jeunghwan LEE, Seoul (KR); Hyuck YOO, Seoul (KR)

(73) Assignee: KOREA UNIVERSITY RESEARCH AND BUSINESS FOUNDATION, Seoul (KR)

(21) Appl. No.: 18/329,706

(22) Filed: Jun. 6, 2023

(30) Foreign Application Priority Data
Nov. 8, 2022 (KR) 10-2022-0147865

(51) Int. Cl. G06N 3/096

(52) U.S. Cl. CPC G06N 3/096

(57) ABSTRACT

Disclosed is a prediction model generation method for predicting training time and resource consumption required for distributed deep learning training and a prediction method using the prediction model. The prediction model generation method is performed by a computing device including at least one processor and includes constructing a training dataset; and generating a prediction model by training a graph neural network (GNN). The training dataset includes input data and result data, the construction of the training dataset includes converting a distributed deep learning training code (distributed training (DT) code) to a graph; and extracting an adjacency matrix and a feature matrix from the graph.

### CROSS-REFERENCE TO RELATED APPLICATIONS

This application claims the benefit under 35 USC § 119(a) of Korean Patent Application No. 10-2022-0147865 filed on Nov. 8, 2022, in the Korean Intellectual Property Office, the entire disclosure of which is incorporated herein by reference for all purposes.

### BACKGROUND

### 1. Field

At least one example embodiment relates to a system for training a distributed deep learning model and, more particularly, to technology for predicting resource consumption of a graphics processing unit (GPU), a network, and a GPU memory used for training of a distributed deep learning model and a burst time for actually occupying corresponding resources and an idle time.

### 2. Description of Related Art

Currently, deep learning is employed in a wide range of various application fields, for example, computer vision, natural language processing, financial transactions, healthcare, and autonomous driving. To support various application fields, a deep learning model continuously evolves into a progressively larger model with the addition of more layers and parameters. For example, over the past ten years, the parameter size of the deep learning model has increased by 2,917 times larger, leading to further increasing the training time required to train a single model.

To cope with a rapidly increasing training time, an accelerator such as a graphics processing unit (GPU) is essential for training, and furthermore, a distributed deep learning (DDL) that trains a single model using a plurality of nodes (workers) equipped with the GPU is essentially utilized.

A most commonly used method for distributed deep learning is a data parallel method that distributes and learns training data using a plurality of GPU nodes (workers) and updates learned model parameters (model weights, etc.). In the data parallel method, each worker performs forward and backward propagations for distributed training data and generates a gradient value for a model parameter. Parameters of the model are updated from gradient values, and network communication is required to aggregate the gradient values of workers for updating.

A network communication method essentially employs two techniques, for example, a parameter server (PS) structure and an all-reduce structure. In the PS structure, a separate node (PS) is present to collect gradients, update model parameters, and transmit the same to workers. In the PS structure, each worker exchanges model parameters with the PS and updates parameters. The all-reduce structure refers to a method in which each worker transmits and updates model parameters to all the workers every training without the PS.

An update method largely includes a synchronous update method and an asynchronous update method. In the synchronous update method, all the workers wait until the training is completed, aggregate and update model parameters, and perform subsequent training. On the contrary, in the asynchronous update method, subsequent training is individually performed after exchanging model parameters every time the training of each worker is completed.

A graph neural network (GNN) refers to a specific type of machine learning algorithm that uses a graph as an input feature of a prediction model. A general machine learning algorithm (e.g., a deep neural network (DNN) and a convolutional neural network (CNN)) operates based on a fixed size of the input (e.g., image, text, and numerical value). On the contrary, even though each graph contains the same type of information, the number of nodes and the number of edges are different and thus, each graph has a different size (irregular).

To perform prediction based on a graph that is such atypical data, the GNN generates an embedding that is a reduced value representing the graph. The GNN is configured with a plurality of graph layers. Each graph layer generates an embedding for each node. In detail, each layer generates an embedding by aggregating features (feature vectors) of neighbor nodes separated by one hope for each node. For example, if n graph layers are present, each node embedding ultimately becomes a value acquired by reducing feature vectors of neighbor nodes separated up to n hops. Here, the method of calculating a node embedding inside each graph layer is different for each algorithm, such as a graph convolutional network (GCN), a graph isomorphism network (GIN), a graph attention network (GAN), and the like.

Also, the GNN generates a “graphic embedding” that is a fixed-sized vector reducing the entire graph based on the generated node embedding. The process of generating a graph embedding is called a graph readout. There are various methods, for example, methods of summing, averaging, and sorting node embeddings, or using another neural network. Since the generated graph embedding is a fixed-sized vector that reduces a variable-sized graph, an intended prediction is performed by allowing this value to go through another machine learning algorithm, for example, a multilayer perceptron (MLP).

Distributed deep learning requires a plurality of nodes and, thus, is performed in a public cloud, such as Google Cloud, Amazon AWS, and Microsoft Azure, or in an on-premise GPU cluster of each company or research institution. Here, the biggest issue is that an optimal amount of computing resources and training time required for training of distributed deep learning is not known. Therefore, deep learning model developers perform resource provisioning using a trial-and-error or an ad-hoc method. Considering 1) that GPU is very expensive among computing resources and 2) a long training time from several hours to several days, it is very inefficient to repeat computation several times without predicting an optimal amount of resources required for actual computation.

The difficulty in predicting resource consumption is the complexity of a running environment of distributed deep learning (e.g., distributed training (DT) setting). For example, training of the same model may be performed through a large number of GPUs (e.g., 2080 Ti, Titan RTX, V100, A100). Also, the number of PSs and the number of workers may be configured through infinite combinations. Then, workers may be provided to the same server and perform network communication through PCIe, and may be provided to different physical servers and perform communication through 40 GbE or high-speed RDMA. The diversity of this environmental configuration increases the complexity of resource consumption prediction.

In addition, a workload (DT workload) itself that is a target of distributed deep learning training also complicates prediction. The aspect of the resource consumption significantly varies depending on which model is to train, which dataset is used, and 3) which hyperparameter is used.

To solve serious issues occurring due to unawareness of resources in distributed deep learning training, several attempts have been made to predict resource consumption. Justus et al. attempted to predict an execution time of a commonly used layer in a deep learning model, such as a convolution layer (Daniel Justus, John Brennan, Stephen Bonner, and Andrew Stephen McGough. 2018. Predicting the computational cost of deep learning models. In 2018 IEEE international conference on big data (Big Data). IEEE, 3873-3882.). Habitat measured the time of executing a single iteration on a GPU and predicted the time of another GPU through a pre-trained MLP (X Yu Geoffrey, Yubo Gao, Pavel Golikov, and Gennady Pekhimenko. 2021. Habitat: A Runtime-Based Computational Performance Predictor for Deep Neural Network Training. In 2021 USENIX Annual Technical Conference (USENIX ATC21). 503-521.). Lin et al. profiled GPU and CPU utilization for DT and computed an iteration time for a single minibatch (Zheyu Lin, Xukun Chen, Hanyu Zhao, Yunteng Luan, Zhi Yang, and Yafei Dai. 2020. A Topology-Aware Performance Prediction Model for Distributed Deep Learning on GPU Clusters. In 2020 IEEE International Conference on Big Data (Big Data). IEEE, 2795-2801.).

The attempts are made based on the fact that distributed deep learning training repeats an iteration (one-time forward propagation and backward propagation) and that resource consumption methods are similar during the iteration. However, since the diversity of DT settings and DT workloads is not considered, it may not be used when a new model, a new dataset, and a new hyperparameter are used. In addition, it may not be applied to different types of GPUs, different numbers of PSs and workers, and different types of network connections. That is, there are limitations in accommodating the variety of various settings and workloads together.

Therefore, the present invention proposes a prediction method that may predict resource consumption and time for various DT workloads and also may apply to various DT settings. In detail, the present invention proposes a method of accurately predicting resource consumption for various DT workloads with respect to a given DT setting based on a graph neural network. Further, the present invention proposes a method of training a prediction model for different DT settings with small loads using transfer learning (TL).

The present invention may be differentiated as follows:
1) To predict resource consumption in distributed deep learning, this is the first approach that can predict infinitely diverse DT workloads as input of prediction using a GNN.
2) By analyzing (profiling) more than 800 types of representative deep learning models in detail, \textcircled{1} resource consumption, \textcircled{2} burst time, and \textcircled{3} idle time that are resource consumption measurement metrics suitable for prediction are proposed.
3) A total of 12 values are predicted by predicting resource consumption, burst time, and idle time with respect to 4 key resources that are considered in a distributed deep learning system (e.g., GPU utilization, GPU memory utilization, network TX throughput, and network RX throughput).
4) A size of the dataset required for training and training time are improved by 2.5 times and 7.3 times using transfer learning, and a high prediction accuracy is maintained.

### SUMMARY

A technical subject of at least one example embodiment is to provide a method and device for predicting resource consumption required for training of distributed deep learning and a burst time for actually occupying resources and idle time.

According to an aspect of an example embodiment, there is provided a prediction model generation method performed by a computing device including at least one processor, the prediction model generation method including constructing a training dataset; and generating a prediction model by training a graph neural network (GNN). The training dataset includes input data and output data, and the construction of the training dataset includes converting a distributed deep learning training code (a distributed training (DT) code) to a graph; and extracting an adjacency matrix and a feature matrix from the graph.

Also, the result data may include at least one of graphics processing unit (GPU) utilization, GPU memory utilization, network transmission (TX) throughput, network reception (RX) throughput, a burst time of a GPU, a burst time of a GPU memory, a burst time of a network TX, a burst time of a network RX, an idle time of the GPU, an idle time of the GPU memory, an idle time of the network TX, and an idle time of the network RX.

Also, the GNN may be implemented as a graph convolutional network (GCN), a graph isomorphism network (GIN), or a graph attention network (GAN).

Also, the GNN may include a plurality of graph layers, a graph readout layer, and a multilayer perceptron (MLP) layer.

Also, each of the graph layers may include a gated recurrent unit (GRU).

Also, the prediction model generation method may further include performing transfer learning (TL) on the prediction model after generating the prediction model.

Also, the performing of the transfer learning may be performed using a second training dataset, the training dataset may be a dataset corresponding to a first distributed training (DT) setting, the second training dataset may be a dataset corresponding to a second DT setting, and the first DT setting and the second DT setting may be different in at least one type of GPU that performs distributed deep learning, the number of parameter servers (PSs), and the number of worker nodes.

Also, the transfer learning may update at least one of the parameters of at least some graph layers among a plurality of graph layers included in the prediction model and parameters of an MLP layer included in the prediction model.

Also, the transfer learning may update the parameters of the latter half layers of a plurality of graph layers included in the prediction model and parameters of an MLP layer.

According to an aspect of at least one example embodiment, there is provided a prediction method using a prediction model generated by the above prediction model generation method, the prediction method including generating input data to be predicted; and performing prediction by inputting the input data to be predicted to the prediction model.

A prediction model generation method and a prediction method according to example embodiments may easily predict information on resource consumption and training time required for training of distributed deep learning.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIGS. 1A and 1B illustrate examples of explaining machine learning on different input types: FIG. 1A illustrates an example of a convolutional neural network (CNN) applied to an image, and FIG. 1B illustrates an example of a graphics neural network (GNN) applied to a graph;

FIGS. 2A, 2B, and 2C illustrate network RX throughput (T_{NR}) for workload 1, GPU utilization (U_{G}) for workload 2, and GPU memory utilization (U_{GM}) for workload 3, respectively;

FIG. 3 illustrates an example of explaining a prediction process using a prediction method proposed by the present invention;

FIG. 4 illustrates an example of explaining an operation of an input builder on a VGG16 model;

FIG. 5 illustrates an example of explaining a generation process of a training dataset;

FIG. 6A is a graph showing a prediction error for each scenario;

FIG. 6B is a graph showing a training time for each scenario;

FIG. 7 is a flowchart illustrating a training dataset generation method according to an example embodiment;

FIG. 8 is a flowchart illustrating a prediction model generation method according to an example embodiment; and

FIG. 9 is a flowchart illustrating a prediction method according to an example embodiment.

### DETAILED DESCRIPTION

The aforementioned features and effects of the disclosure will be apparent from the following detailed description related to the accompanying drawings, and accordingly, those skilled in the art to which the disclosure pertains may easily implement the technical spirit of the disclosure.

Various modifications and/or alterations may be made to the disclosure, and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Although the terms “first,” “second,” and the like are used to explain various components, the components are not limited to such terms. These terms are used only to distinguish one component from another component.

For example, a first component may be referred to as a second component, or similarly, the second component may be referred to as the first component within the scope of the present disclosure. As used herein, the term “and/or” includes any and all combinations of one or more of the associated listed items.

As used herein, the singular forms “a,” “an,” and “the” are intended to include the plural forms as well unless the context clearly indicates otherwise. It will be further understood that the terms “comprises” and/or “comprising,” when used in this specification, specify the presence of stated features, integers, steps, operations, elements, components or a combination thereof but do not preclude the presence or addition of one or more other features, integers, steps, operations, elements, components, and/or groups thereof.

Hereinafter, example embodiments will be described with reference to the accompanying drawings. However, the scope of the patent application is not limited to or restricted by such example embodiments. Like reference numerals used herein refer to like elements throughout.

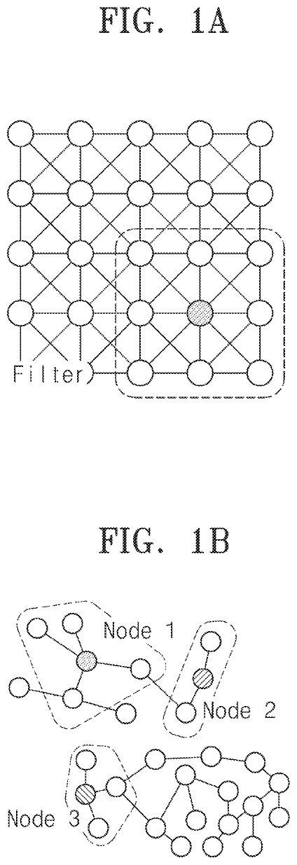

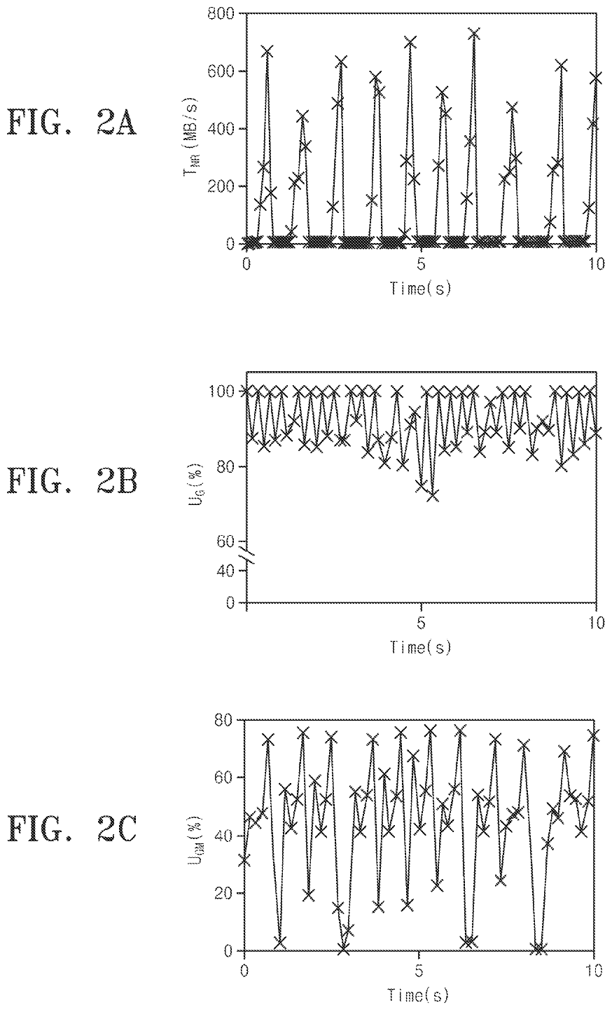

FIG. 1A illustrates an example of a convolutional neural network (CNN) applied to an image.

An image of a fixed size, that is, an image having a fixed number of pixels, is input to the CNN. The CNN aggregates information from the fixed number of pixels (called filter) and outputs a vector value that represents a section of the image (known as convolved feature). For example, in FIG. 1A, a filter of 9 pixels yields a single convolved feature from a lower-right corner of the image. As an input size and a filter size are fixed, the same number of convolved features are derived from each input image.

On the other hand, in a graphics neural network (GNN), the information of a graph is primarily aggregated for each node. This aggregated result may represent node embedding. In detail, node embedding is calculated as an aggregation of features of neighbor nodes within a specific hop distance of each node. In FIG. 1B, within one hop distance, node 1 has four neighbor nodes, node 2 has two neighbor nodes, and node 3 has three neighbor nodes. Node embedding of the GNN may aggregate a different number of neighbor nodes. Therefore, each GNN algorithm performs different methods for calculating node embeddings. Also, unlike input images in the CNN, the GNN receives a graph that includes a different number of nodes. To accommodate diverse sizes, the GNN generates a graph embedding that is a fixed-size vector representing a graph.

Also, the GNN includes the same number of novel parameters as the number of layers. Each layer of the GNN generates a node embedding by aggregating information from nearby nodes in a single hop. Also, the node embedding may aggregate neighbor nodes up to n hops away by stacking n layers. The number of layers to be used differs according to a use-case of the GNN.

The graph embedding may be used to perform prediction in combination with a traditional machine learning algorithm, such as a multi-layer perceptron (MLP). Here, a GNN-based prediction model is designed to predict the resource consumption of DT workloads with respect to various DT settings. Similar to existing deep learning algorithms, the GNN is trained by repetitive iterations (forward propagation and backward propagation).

Hereinafter, definitions related to terms used herein are described.
Deep learning model training: refers to a process of updating a model until a plurality of layers and parameters that constitute the model configured in each layer converge to a value capable of most well predicting a prediction value for an input value of a given dataset.
Iteration: refers to a process of performing a one-time forward propagation and backward propagation based on a batch of a dataset.
Forward propagation: refers to a process of calculating and storing variables by sequentially passing through layers from an input layer to a final output layer of a deep learning model.
Backward propagation: refers to a process of calculating gradients of each layer parameters from the final output layer to the input layer based on a difference between a prediction value output as a result of the forward propagation and ground truth.

Hereinafter, definitions of prediction metrics are explained.

To define prediction metrics, about 832 DT workloads are constructed by combining a representative image classification and natural language processing model, datasets, and hyperparameters. In detail, workloads are derived from the following Table 1.

TABLE 1

| Model type | Model | Dataset | Hyperparameters |
|---|---|---|---|
| Image | AlexNet, GoogLeNet (Inception v1), Inception v3, | CIFAR-10, | Batch size, parameter |
| classification | Inception v4, ResNet101, ResNet101_v2, ResNet152, | ImageNet | precision (floating-point), |
| | ResNet20, ResNet20_v2, ResNet32, ResNet32_v2, | | optimizer, data format, |
| | ResNet44, ResNet44_v2, ResNet50, ResNet50_v2, | | synchronization method |
| | ResNet56, ResNet56_v2, ResNet110, ResNet110_v2, | | |
| | ResNet152, ResNet152_v2, VGG11, VGG16, VGG19, | | |
| | Overfeat, DenseNet100_k12, DenseNet100_k24, | | |
| | DenseNet40_k12 | | |
| Natural | NMT_Big, NMT_Medium, NMT_Small, Transformer, | Europarl | |
| language | Transformer_AAN, Transformer_Big | | |
| processing | | | |

Initially, each DT workload is trained with one PS and two workers (each using V100 GPU). During the progress of training, 1) GPU utilization (U_{G}), 2) GPU memory utilization (U_{GM}), 3) network TX throughput (T_{NT}), and 4) network RX throughput (T_{NR}) are measured. The aforementioned four types of resources are metrics considered useful in optimizing DT systems in relevant studies. Measurements were performed during 100 iterations. The measurement result shows similar patterns over 832 workloads and is described based on three example workloads.
Workload 1: NMT Medium model, Europarl dataset (batch size 32, asynchronous training)
Workload 2: DenseNet40_k12 model, CIFAR-10 dataset (batch size 512, synchronous training)
Workload 3: Inception v3 model, ImageNet dataset (batch size 128, asynchronous training)

FIGS. 2A, 2B, and 2C illustrate network RX throughput (T_{NR}) for workload 1, GPU utilization (U_{G}) for workload 2, and GPU memory utilization (U_{GM}) for workload 3, respectively. In each graph, the x-axis represents time, and the y-axis represents resource consumption. All three graphs show cyclic patterns-repeatedly alternating data points of high and low resource consumption.

Therefore, the present invention quantifies such patterns and defines measurement metrics of resource consumption. Data points of high resource consumption are referred to as burst points, and data points of low resource consumption are referred to as idle points, which may be quantified based on the x-axis and the y-axis. Here, a predetermined threshold may be used. That is, a point showing consumption greater than (or greater than or equal to) the threshold may be referred to as a burst point and a point showing consumption less than the threshold may be referred to as an idle point. The threshold may have a value predefined by a user or a manager or may be variable depending on example embodiments. Also, burst utilization may represent the average amount of resources consumed at resource burst points, and the idle time may represent the average time in which idle points continuously appear.

Table 2 shows quantified values of the defined metrics (i.e., amounts and durations of burst and idle data points) illustrated in FIGS. 2A, 2B, and 2C. Resource consumption shows great difference between burst and idle points. For T_{NR}, the amount differs by 83X. Also, once T_{NR} is utilized, it is consumed over 0.33 s on average. Conversely, the idle time of T_{NR} is about 0.7 s, which is about 2.12X longer than the burst time (burst duration). Also, significant difference is observed in U_{G} and U_{GM}.

TABLE 2

| | T_{NR} (workload 1) | U_{G} (workload 2) | U_{GM} (workload 3) |
|---|---|---|---|
| Burst | 374.3 MB/s, 0.33 s | 98.8%, 0.19 s | 54.4%, 0.64 s |
| Idle | 4.5 MB/s, 0.7 s | 84.6%, 0.21 s | 16.8%, 0.28 s |

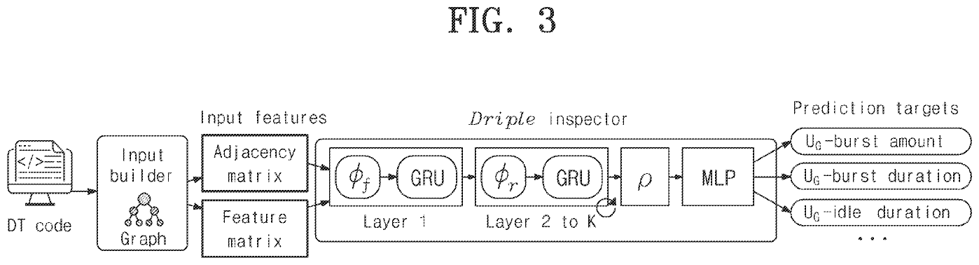

FIG. 3 illustrates an example of explaining a prediction process using a prediction method (referred to as Driple) proposed by the present invention. The prediction process is performed by an input builder (input builder of FIG. 3) and a predictor (Driple inspector of FIG. 3).

The input builder may extract a computational graph from a code of a DT workload and may build an adjacency matrix and a feature matrix. The predictor receives the generated adjacency matrix and feature matrix as input and performs prediction on metrics (e.g., 12 metrics). That is, the predictor may generate a prediction model by training a GN model using a training dataset and may generate a prediction value for input data using the generated prediction model. Depending on example embodiments, the input builder may be referred to as an inputter, an input unit, or an input generator, and the predictor may also be referred to as a prediction unit, a prediction model generator, a prediction model generation unit, a trainer, and a training unit.

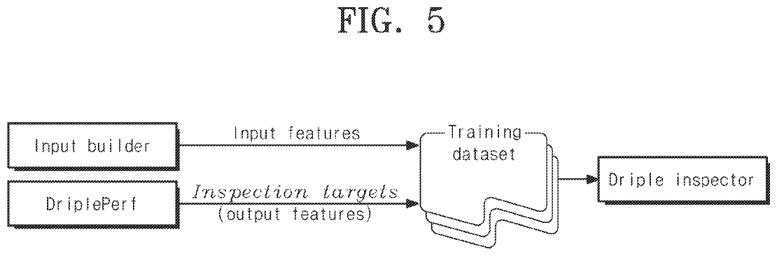

Also, the input builder (Input builder of FIG. 3 and/or FIG. 5), the predictor (Driple inspector of FIG. 3 and/or FIG. 5), and a measurer (DriplePerf of FIG. 5) represent to be functionally and logically separable and do not represent that each component is divided into a separate physical device or a separate code. Also, the input builder, the predictor, and the measurer may represent functional and structural combination of hardware for performing the technical spirit of the present invention and software for driving such hardware. For example, the components may represent a predetermined code and a logical unit of hardware resources for performing the predetermined code and do not represent a physically connected code or a single type of hardware.

The key of the present invention lies in that deep learning libraries used for distributed deep learning training convert each DT workload to a “graph.” Most libraries, for example, TensorFlow, PyTorch, Caffe, and MXNet, generate a graph that represents all operations, variables, and constants of the training process as nodes of the graph and an operation process as an edge.

Herein, a computational graph is represented as G=(N, E). Here, N denotes a set of individual nodes, and E denotes a set of edges. Individual node n has node feature Xₙ to express characteristics and information on a node. An i-th node of the graph is expressed as nᵢ(nᵢ ∈ N). Each layer of a model is converted to multiple low-level operations, for example, Add and MatMul, called “op.” This op becomes n. Also, a dataset is expressed as an op (e.g., VariableV2 in TensorFlow) that loads data to start an iteration, so it is another n. Variables and constants required for each op become another n (e.g., Const) as well. Each n has different features Xₙ (e.g., node type) since nodes are of different types, such as computation (e.g., MatMul), dataset, and variables.

Also, hyperparameters of the DT workload are converted as nodes or features of nodes. For example, when an optimizer is changed (e.g., RMSProp and Momentum), optimizer nodes in G are replaced with nodes of a new optimizer. Also, a batch size determines the amount of dataset to be fed. The batch size is reflected as n's Xₙ. In particular, the ML library sets the batch size to a “tensor size” feature of VariableV2. As another example, parameter precision in Table 1 represents a type of floating-point operations. Also, when a 16-bit floating-point operation is used, TensorFlow library changes relevant n's Xₙ (e.g., DT HALF). Other parameters are similarly reflected in G.

Herein, an edge that connects nᵢ and nⱼ is expressed as eᵢⱼ. Edges determine the execution order of ops (e.g., from a VariableV2 op that loads data for an iteration to ops of a last layer). When G is generated from a DT code, a deep learning library places G on a device (e.g., GPU) and executes training following edges, starting from a first n. For each node n of G, nodes connected through a single edge to n are called neighbors. Here, N(n) denotes a set of neighbors.

The input builder generates an adjacency matrix and a feature matrix. The adjacency matrix is for representing nodes and edges of each graph. To be expressed as the adjacency matrix, nodes in the graph are numbered. Given G=(N, E), the size of the adjacency matrix is m×m. Here, m is |N|. An element corresponding to an i-th row and a j-th column of the adjacency matrix has a value of 1 if an edge from nᵢ to nⱼ is present and has a value of 0 if the edge is absent. Therefore, the adjacency matrix includes only information on 1) presence of nodes and 2) connectivity (i.e., edge) between the nodes.

The feature matrix includes Xₙ, such as a tensor size and a node type. Nodes in G have different types (ops) and different numbers of features depending on the nodes. For example, Xₙ of VariableV2 has the tensor size, but Conv2D does not have the tensor size. Also, all nodes have the node type as Xₙ. However, for a GNN to train graphs, each node needs to have the same features. Also, the number of features does not need to be too large since the number of features affects training time and prediction accuracy. If the number of features in Xₙ is f, the feature matrix has a size of m×f.

To determine features to be included in Xₙ, features used in previous GNN studies were checked. The previous studies used the GNN for optimization of the deep learning model, such as placing graph partitions between GPUs and graph optimization (compiler). However, such studies do not predict the resource consumption of DT workloads.

Features are classified into two categories, that is, 1) features related to individual nodes and 2) features related to the internal states of a graph (including data transition between nodes). Herein, two features are selected as follows:
Node type: Examples of the node type include Conv2D and L2Loss. Therefore, the node type in G is given as a text value. To use the node type as an input feature, a type value may be converted to a number. In detail, frequency encoding of the setting frequency of the node type that appears in a dataset may be utilized.
Tensor size: The tensor size is important for computation and communication in DT. For n that does not have the tensor size as Xₙ, 0 may be allocated as the tensor size.

In addition to the above two features, another feature that reflects a “grouping” mechanism is introduced. Herein, a grouping operation is a selective configuration and thus, is not a configuration to be necessarily employed. The grouping mechanism is to group graph nodes into a graph with a fewer number of nodes, which improves training efficiency. This feature is referred to as a “grouped node size,” which represents how many nodes are grouped into a corresponding node.

Grouping has two aims. First, grouping aims to reduce the size (|N| and |E|) of G. Graphs of DT workloads in Table 1 have thousands of nodes and edges (maximum number of nodes and maximum number of edges are 18,758 and 28,276 (transformer model), respectively (with average values of 2,923 and 3,982, respectively)). Many nodes and edges may reduce the prediction accuracy of the GNN. Also, since the number of edges is large, it requires a large amount of time to calculate node embeddings. Therefore, the total training time tends to increase exponentially.

Second, grouping enables batching in training graphs, which is important for training speed. Batching represents that the GNN is updated not for individual input data (a single graph) but for a set of data called a batch. For example, a batch size of 10 represents that model parameters are updated after 10 graphs go through a GNN model. Here, the number of layers in the GNN model may differ according to a change in the number of nodes of a graph (m). Therefore, for batching, m needs to be identical for each graph within a batch. Obviously, input graphs have different m, which makes it difficult to perform batching work.

Herein, two grouping policies (i.e., uniform and proportional) are designed. Each policy partitions input graphs into batches and sets the scale of “node grouping.” Let M be the number of grouped nodes in a graph (e.g., 500 grouped nodes may be derived from 19,758 original nodes). Uniform grouping sets M to be identical across all batches.

Proportional grouping first sorts input graphs in ascending order based on m. Then, the graphs are partitioned in order of m by batch size. Therefore, the first batch includes graphs, each with a small number of nodes, and subsequent batches include larger graphs. For each batch, the average number of nodes (V) is computed, and M is set to log₁₀v nodes (empirically selected in consideration of a GPU memory size required to load a batch).

The input builder performs node grouping according to M. Node grouping may be based on a fluid communities algorithm (Ferran Pares, Dario Garcia Gasulla, Armand Vilalta, Jonatan Moreno, Eduard Ayguade, Jesus Labarta, Ulises Cortes, and Toyotaro Suzumura. 2018. Fluid Communities: A Competitive, Scalable and Diverse Community Detection Algorithm. In Complex Networks & Their Applications VI, Chantal Cherifi, Hocine Cherifi, Marton Karsai, and Mirco Musolesi (Eds.). Springer International Publishing, Cham, 229-240.). The algorithm selects M seed nodes in a graph and groups the remaining nodes around seed nodes.

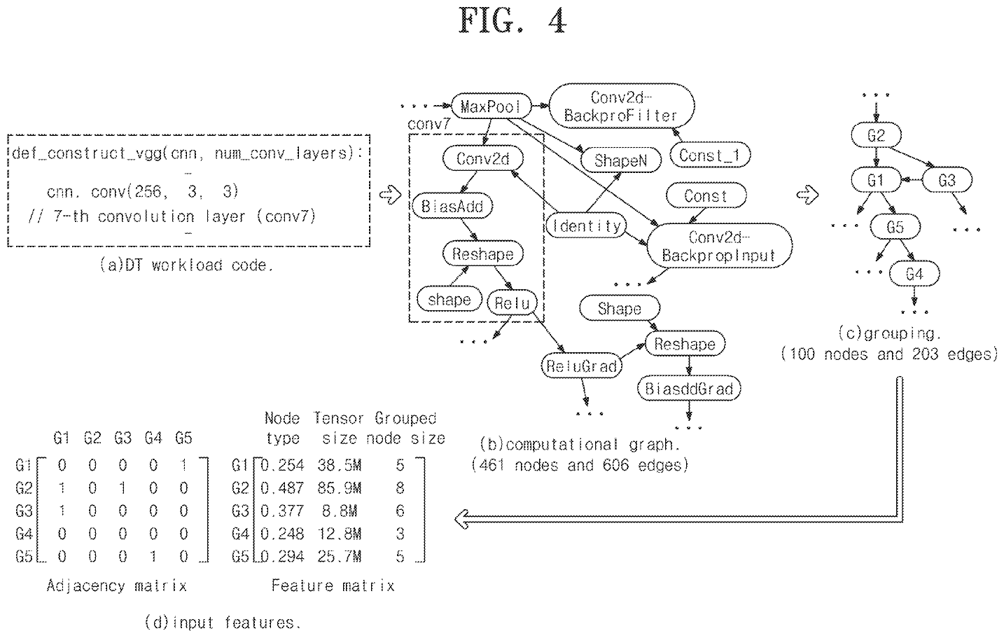

Hereinafter, an example of an operation of the input builder is described. FIG. 4 illustrates an operation of an input builder on a VGG16 model. A 7-th convolution (conv7) layer among the entire layers of the VGG16 model is described. A line that defines the conv7 layer in a DT workload code (see (a) of FIG. 4) generates multiple nodes in G. Nodes for mathematical operations in a forward propagation are illustrated in a dashed box of the conv7 layer (see (b) of FIG. 4). Other nodes are related to variables, constants, and preceding operations. In total, 16 nodes are generated for the conv7 layer. Then, the mathematical operations in the con7 layer are grouped into a single group (G1) (see (c) of FIG. 4). Likewise, other nodes form groups, such as G2 to G5. Finally, the input builder generates the adjacency matrix and the feature matrix that are inputs of a predictor (Driple inspector) (see (d) of FIG. 4).

For example, the input builder of the present invention extracts a graph from a given code and converts the graph to a form of a matrix received by a GNN. In a conversion process, selection of feature values of a node to be used in the GNN and grouping of graph scale are performed.

The predictor of the present invention is designed based on the GNN that receives the adjacency matrix and the feature matrix as input. That is, the predictor may be understood as a composition that generates a prediction model by training the GNN model using a training dataset or performs a prediction operation using the generated prediction model.

The first part of the predictor (or the prediction model) relates to multiple graph layers. A graph layer executes an update function ϕ. Here, the first layer is denoted as ϕf and the remaining layers are denoted as ϕr since their update functions differ.

The first layer ϕf executes an update function of aggregating Xₙⱼ of nⱼ that belongs to N(nⱼ) for all nᵢ. An aggregated value by ϕf becomes a node embedding of nᵢ, which is referred to as hₙ_{₁}¹. Therefore, the node embedding of the first layer may be generated according to Equation 1.

hₙ_{ᵢ}¹=ϕ_{f}=AGGREGATE¹(Xₙ_{ⱼ}|nⱼ∈N(nᵢ)),i=1, . . . ,m [Equation 1]

Next layers (e.g., k-th layer) perform two update stages (ϕᵣ) for each nᵢ. That is, 1) aggregates a (k−1)-th layer's node embedding hₙ_{₁}^{k-1} of nⱼ that belongs to N₍ₙ_{ᵢ}₎ and 2) the aggregated node embeddings are combined with hₙ_{ᵢ}^{k-1} of nᵢ. A method of combining the node embeddings differs for each GNN algorithm. Since there is a plurality of layers that performs ϕᵣ, k-th updated embedding value of nᵢ is denoted as hₙ_{ᵢ}^{k}, which is represented as Equation 2.

hₙ_{ᵢ}^{k}=ϕᵣ=COMBINE^{k}(hₙ_{ᵢ}^{k-1},AGGREGATE^{k}(hₙ_{ⱼ}^{k-1}|nⱼ∈N(nᵢ)),i=1, . . . ,m [Equation 2]

Suppose that 1-th G in a training dataset is Gₗ(Gₗ=(Nₗ, Eₗ) and |Nₗ|=m) and a value K denotes the number of layers in the GNN. If K is set to m (number of nodes in Gₜ), node embeddings are aggregated m times. Therefore, Xₙ of neighbors in m hop are aggregated and combined. Usually, the GNN sets the number of GNN layers (K) to be similar to m or to be half of m. According to an example embodiment, K may be set to a half of m, showing the highest prediction accuracy in experiment results. However, the scope of the present invention is not limited to a specific value of K. Parameters of ϕᵣ, such as weight and bias, may be identical across (K−1) ϕᵣ layers. This is a common design selection to reduce computational costs in training and inference.

Calculations of Equation 1 and Equation 2 depend on GNN algorithms. For example, a graph convolution network (GCN) uses a normalized mean for an aggregation update function. Also, a graph attention network (GAT) uses a weighted sum on hₙ_{ᵢ}^{k} with weights calculated by an attention mechanism that calculates importance (i.e., weight) of Xₙ. Herein, four GNN algorithms, that is, GCN, GAT, GIN, and message passing neural network (MPNN), are tested, and the prediction accuracy of the GCN is verified to be highest. Therefore, although the present invention may use the GCN, the present invention is not limited thereto.

Additionally, as illustrated in FIG. 3, the present invention introduces ϕ_{f} and ϕᵣ, and gated recurrent units (GRUs) at the end of layers, respectively. Therefore, the first layer (layer 1) of the predictor (Driple inspector) includes a pair of ϕ_{f} and GRU. This is to prevent an over-smoothing issue caused by information loss in previous layers as the number of layers increases.

After allowing hₙ_{ᵢ}^{k} values to go through the GRU, the predictor generates a graph embedding h_{G}_{ₗ} for Gₗ. h_{G}_{ₗ} may be generated by a graph readout layer (ρ). ρ layer executes a pooling function over hₙ_{ᵢ}^{k} values of nᵢ that belong to Nₗ in Gₗ. The ρ layer is expressed as Equation 3.

h_{G}_{ₗ}=ρ=POOL(hₙ_{ᵢ}^{K}|nᵢ∈Nₗ) [Equation 3]

Similar to ϕ_{f} and ϕᵣ, various ρ layers may be selected. There are simple pooling functions for converting a given hₙ_{ᵢ}^{K} value to h_{G}_{ₗ} through mathematical operations (e.g., mean, maxi, or sum). Also, sort is another simple pooing function that selects a specific number of hₙ_{ᵢ}^{K} values in descending (or ascending) order and returns the selected values as final k_{G}_{ₗ}. Due to ease of implementation and fast training, such simple pooling functions are widely used. Also, the ρ layer may be implemented as a separate neural network. For example, set2set uses LSTM neural network. To generate h_{G}_{ₗ}, set2set regards the hₙ_{ᵢ}^{K} values as time-series data and assigns a weigh to importance between the hₙ_{ᵢ}^{K} values. Among such selections, the present invention uses set2set. However, the scope of the present invention is not limited thereto. This design or selection may be based on the test result for the prediction accuracy.

Finally, the predictor transmits h_{G}_{ₗ} generated by the ρ to an MLP. Regarding the MLP, the present invention selects three fully connected layers according to the measured prediction accuracy. However, the scope of the present invention is not limited thereto. The MLP generates a prediction result for 12 targets for given Gₗ.

For example, the predictor of the present invention is designed based on the GNN. The first to k-th layers are graph layers of the GNN. GCN, GIN, GAT, MPNN, and the like may be used as the graph layers. Although the GCN showing the highest accuracy as a test result is selected in the present invention, the scope of the present invention is not limited thereto. Also, a GRU layer may be added at the end of each graph layer, which is to prevent loss of information learned in previous layers and/or over-smoothing issue as the number of layers increases.

Also, as graph readout layers that generate graph embeddings, sum, mean sort, set2set (use of LSTM based neural network), and the like may be used. Although set2set showing the highest accuracy as an evaluation result is used in the present invention, the scope of the present invention is not limited thereto. A generated graph embedding value may be transmitted to a fully connected layer, and metrics (e.g., 12 metrics) may be predicted.

To train the predictor, a dataset is required. However, there is no dataset on various models and resource consumption in a distributed deep learning process. Therefore, a method of directly generating a dataset is proposed herein.

The dataset is generated through the input builder and the measurer (DriplePerf of FIG. 5) and generated per DT setting. As described above, the input builder generates a matrix that is an input value of the model from the DT code. When training is performed for the given DT code, the measurer (also, referrable to as a measurement section and a measurement unit) measures GPU utilization, GPU memory utilization, network TX throughput, and network RX throughput. As illustrated in FIG. 5, input features and prediction targets become a training dataset of a DT workload.

In conjunction with input features from the input builder, the measurer generates output features for the DT workload. The output features are the results of DT training, and thus, the measurer first measures resource consumption (e.g., U_{G}, U_{GM}, T_{NT}, and T_{NR}) while executing the DT code. The measurement result is generated as data points (measurement time, consumed resource amount) of two-dimensional (2D) coordinates. The measurer extracts output features from the output result.

The measurer executes a k-means clustering algorithm for dividing data points of measurement data. The clustering algorithm categorizes each data point based on a corresponding y-axis value, and the data point is categorized into two parts (burst and idle). Then, the measurer calculates the output features of a given graph as follows. First, a burst amount of each resource is calculated based on the mean value of the consumed resource amount (y-axis). To calculate a burst duration and an idle duration, each consecutive burst and idle points that appear in each measurement may be counted. A period during which the consecutive burst points appear becomes a single burst duration. Also, a time in which idle points appear becomes the idle duration. Normal distributions of burst amount, burst duration, and idle duration are generated. From the distributions, mean values for prediction targets may be acquired.

Through the input builder and the measurer, a training dataset is generated for each DT workload in Table 1. Then, the predictor may be trained.

Herein, proposed is introduction of transfer learning for reducing training time.

Initially, there is a need to verify whether it is possible to perform accurate prediction, that is, countermeasure with a single predictor (or prediction model) for a plurality of different DT settings. In theory, a single predictor may be trained through a dataset of a plurality of DT settings. To test the theory, DT workloads are profiled in two different DT settings using 1) V100 GPU and 2) 2080Ti GPU. In DT settings, only types of GPUs differ, and the remaining DT setting configurations are identical (one PS, two workers, use of PCI).

The above situation is compared through two scenarios. Scenario 1 relates to a single predictor trained by a dataset in which V100 and 2080Ti GPU are integrated (V100+2080Ti), and scenario 2 relates to predictors trained by a dataset of V100 and a dataset of 2080Ti, respectively.

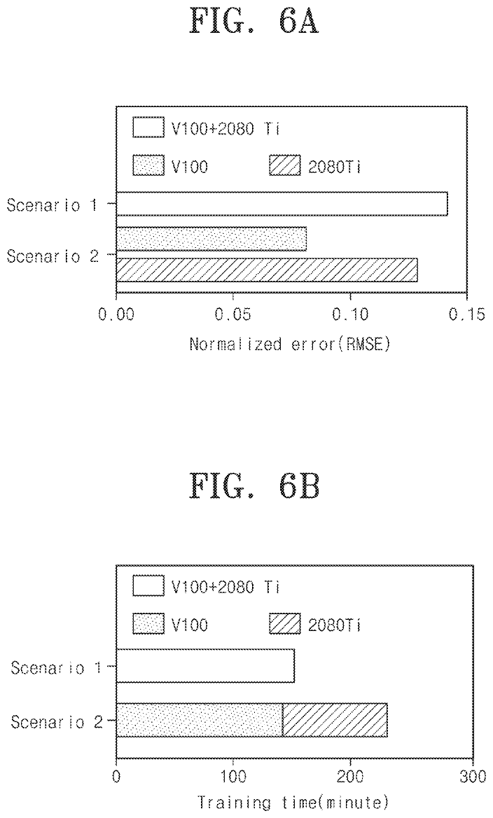

FIG. 6A shows that scenario 2 shows superior accuracy (170% and 110% in V100 and 2080Ti, respectively) compared to scenario 1. Therefore, it can be known that a single predictor may not accurately predict two (or a plurality of) DT settings. Therefore, the present invention generates a separate predictor per DT setting.

However, training the predictor per DT setting requires considerable effort. When a user desires to change DT settings according to a GPU type or the number of GPUs, the number of PSs, the number of workers, and the type of network connection, generating a dataset for each DT setting may be burdensome. For example, in scenario 2 of FIG. 6B, it is found that more than 800 DT workloads are required to achieve reasonable prediction accuracy only for the V100 model.

Further, the training time of each model may be more serious. In FIG. 6B, the training time of scenario 1 is 149.8 minutes, while scenario 2 is 228.5 minutes in total, which is 52% longer than scenario 1. Therefore, the present invention is to outperform the above issue using transfer learning.

The transfer learning refers to a training method of using knowledge of a well-trained model to a new target model. For transfer learning, some layers (parameters) of a pre-trained model may be reused, and some layers may be newly trained.

To apply the transfer learning to the predictor of the present invention, a size of a dataset to be used for transfer learning and layers to be reused or updated need to be determined. The present invention verified that, as a result of reviewing various combinations of dataset sizes and layers, the dataset size has reduced from 800 to 320 and, when some of graph layers (e.g., may be a half as a latter portion of each graph layer) and/or MLP layers are updated, and remaining layers were reused, the accuracy was best. As a detailed example, when four graph layers are present, the parameters of a third graph layer and the parameters of a fourth graph layer may be updated. As another example, when three graph layers are present, half of the parameters of the third graph layer and the parameters of the second graph layer may be updated.

Hereinafter, the experiment result of the method proposed herein is described.

To prove the effectiveness of the present invention, 14 DT settings and more than 800 DT workloads were used. In detail, DT settings are as in the following Table 3.

TABLE 3

| | | DP | | # of GPU |
|---|---|---|---|---|
| Name | GPU | topology | Network | machines |
| V100-P1w2/ho-PCIe | V100 | PS1/w2/ | Co-located | 1 |
| | | homo | | |
| V100-P2w2/ho-PCIe | V100 | PS2/w2/ | Co-located | 1 |
| | | homo | | |
| 2080Ti-P1w2/ho-PCIe | 2080Ti | PS1/w2/ | Co-located | 1 |
| | | homo | | |
| 2080Ti-P1w3/ho-PCIe | 2080Ti | PS1/w3/ | Co-located | 1 |
| | | homo | | |
| 2080Ti-P2w2/he-PCIe | 2080Ti | PS2/w2/ | Co-located | 1 |
| TitanRTX-P2w2/he-PCIe | Titan | hetero | | |
| | RTX | | | |
| 2080Ti-P2w2/he-40G | 2080Ti | PS2/w2/ | 40 GbE | 2 |
| TitanRTX-P2w2/he-40G | Titan | hetero | | |
| | RTX | | | |
| 2080Ti-P4w4/he-40G | 2080Ti | PS4/w4/ | 40 GbE | 2 |
| TitanRTX-P4w4/he-40G | Titan | hetero | | |
| | RTX | | | |
| V100-P5w5/he-1G | V100 | PS5/w5/ | 1 GbE | 5 |
| 2080Ti-P5w5/he-1G | 2080Ti | hetero | | |
| V100-P5w10/he-1G | V100 | PS5/w10/ | 1 GbE | 5 |
| 2080Ti-P5w10/he-1G | 2080Ti | hetero | | |

In table 3 above, a first setting is used as a pre-trained model of transfer learning, and items of experiment are as follows:
Experiment to determine a design of a prediction structure of a prediction model proposed in the present invention: GNN algorithms, the number of layers, graph readout layers, and accuracy comparison and analysis according to a grouping method.
Effect analysis of transfer learning: The training time is improved by 7.3 times through transfer learning, maintaining the accuracy close to the predictor without transfer learning.
Prediction accuracy: 11%, 9%, 17%, and 15% of mean percentage errors for GPU utilization, GPU memory utilization, network TX throughput, and network RX throughput
Use example: Example is the use of a prediction method when selecting a GPU, selecting a batch size, and selecting the number of workers for model training (proposing a combination capable of improving a training time by maximum of 2.4 times in the same environment).

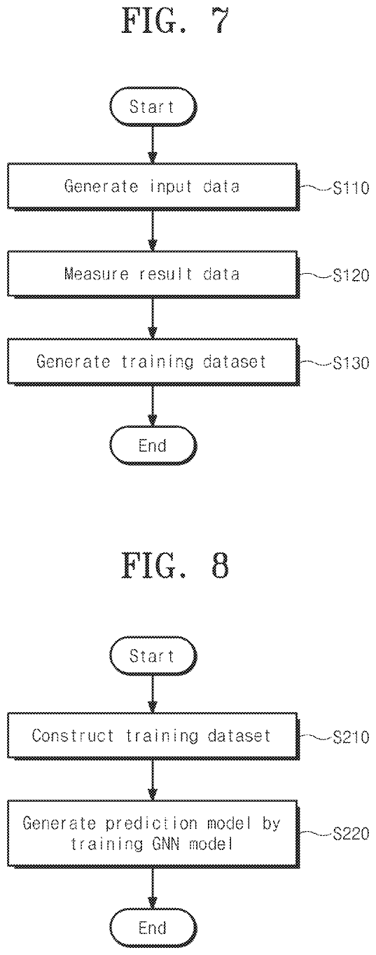

FIG. 7 is a flowchart illustrating a training dataset generation method according to an example embodiment.

The training dataset generation method may be performed by a computing device that includes at least a processor and/or a memory. The computing device may include a personal computer (PC), a server, a tablet PC, a laptop computer, and the like. Depending on example embodiments, at least a portion of operations included in the training dataset generation method may be understood as an operation by the processor of the computing device. Also, the computing device may represent a physically separated single device or may represent a plurality of physically separated computing devices. Hereinafter, in describing the training dataset generation method, detailed description made above in relation thereto is omitted.

In operation S110, input data corresponding to a DT code may be generated. The input data represents an adjacency matrix and a feature matrix for a DT code as input data of a GNN model. To this end, the DT code may be converted to a graph and the adjacency matrix and the feature matrix may be extracted from the converted graph. The DT code may be pre-stored in a storage device included in the computing device.

In operation S120, result data may be measured. The result data may be measured during the progress of training of the DT code as data corresponding to a prediction result of the GNN model. Measured data may be GPU utilization, GPU memory utilization, network TX throughput, and network RX throughput in a training progress process. To this end, a distributed deep learning system for performing training may be used. That is, by proceeding with training using the distributed deep learning system corresponding to a specific DT setting, the aforementioned result data may be measured.

In operation S130, a training dataset may be generated. Training data includes input data and output data of GNN. The output data may represent the measured result data and values corresponding to a plurality of prediction metrics (e.g., 12 prediction metrics) derivable from the result data.

The training dataset needs to be generated for each DT code. Therefore, operations S110, S120, and S130 may be performed sequentially the number of times corresponding to the number of DT codes.

Also, the training dataset may be generated for each DT setting. Therefore, a training dataset corresponding to each of the DT codes may be generated by repeatedly performing the process for each DT setting.

FIG. 8 is a flowchart illustrating a prediction model generation method according to an example embodiment.

The prediction model generation method may be performed by a computing device that includes at least a processor and/or a memory. The computing device may include a PC, a server, a tablet PC, a laptop computer, and the like. Depending on example embodiments, at least a portion of operations included in the prediction model generation method may be understood as an operation by the processor of the computing device. Also, the computing device may represent a physically separated single device or may represent a plurality of physically separated computing devices. Hereinafter, in describing the prediction model generation method, detailed description made above in relation thereto is omitted.

In operation S210, training data may be generated. The training data includes input data of a GNN model and result data corresponding to the input data. To generate the input data, a DT code may be converted to a graph and an adjacency matrix and a feature matrix may be extracted from the converted graph. The DT code and the result data may be pre-stored in a storage device included in the computing device.

The training data may be generated for each DT workload of a predetermined DT setting. Therefore, a training dataset may be generated by repeating an operation the number of times corresponding to the number of DT workloads.

In operation S220, the prediction model may be generated by training a GNN model using the training dataset. Here, the generated prediction model may be a prediction model corresponding to the predetermined DT setting since predicting a plurality of DT settings with a single prediction model may reduce prediction accuracy.

The prediction model generation method may further include performing prediction using the generated prediction model. When performing the prediction, transfer learning is required to predict a DT setting different from the trained DT setting. Therefore, after operation S220, performing transfer learning may be added. The transfer learning may be performed using the training dataset for a DT setting for performing the prediction. In the case of performing the prediction using the prediction model for which the transfer learning is completed, the pre-trained prediction model may perform prediction even for the DT setting different from the trained DT setting with high accuracy.

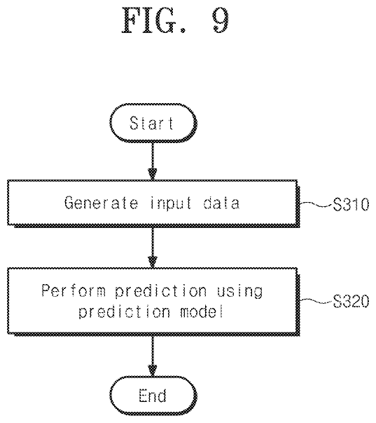

FIG. 9 is a flowchart illustrating a prediction method according to an example embodiment.

The prediction method may be performed by a computing device that includes at least a processor and/or a memory. The computing device may include a PC, a server, a tablet PC, a laptop computer, and the like. Depending on example embodiments, at least a portion of operations included in the prediction method may be understood as an operation by the processor of the computing device. Also, the computing device may represent a physically separated single device or may represent a plurality of physically separated computing devices. Hereinafter, in describing the prediction method, detailed description made above in relation thereto is omitted.

In operation S310, input data corresponding to a DT code may be generated. The input data may represent an adjacency matrix and a feature matrix corresponding to the DT code. In detail, a graph corresponding to the DT code may be generated and the adjacency matrix and the feature matrix may be extracted from the generated graph.

In operation S320, a prediction operation for target metrics may be performed using a prediction model. Here, the prediction model may predict target metrics under a predetermined DT setting as a prediction model for a predetermined DT setting. The prediction model refers to the prediction model generated through the prediction model generation method of FIG. 8 and may be prestored in a storage device included in the computing device.

Also, the entire training time may be derived by multiplying a sum of a predicted idle time and burst time by a total number of iterations.

The aforementioned method according to example embodiments may be implemented in a form of a program executable by a computer apparatus. Here, the program may include, alone or in combination, a program instruction, a data file, and a data structure. The program may be specially designed to implement the aforementioned method or may be implemented using various types of functions or definitions known to those skilled in the computer software art and thereby available. Also, here, the computer apparatus may be implemented by including a processor or a memory that enables a function of the program and, if necessary, may further include a communication apparatus.

The program for implementing the aforementioned method may be recorded in computer-readable record media. The media may include, for example, a semiconductor storage device such as an SSD, ROM, RAM, and a flash memory, magnetic disk storage media such as a hard disk and a floppy disk, optical record media such as disc storage media, a CD, and a DVD, magneto optical record media such as a floptical disk, and at least one type of physical device capable of storing a specific program executed according to a call of a computer such as a magnetic tape.

Although some example embodiments of an apparatus and method are described, the apparatus and method are not limited to the aforementioned example embodiments. Various apparatuses or methods implementable in such a manner that one of ordinary skill in the art makes modifications and alterations based on the aforementioned example embodiments may be an example of the aforementioned apparatus and method. For example, although the aforementioned techniques are performed in order different from that of the described methods and/or components such as the described system, architecture, device, or circuit may be connected or combined to be different from the above-described methods, or may be replaced or supplemented by other components or their equivalents, it still may be an example embodiment of the apparatus and method.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

While the present invention is described above referencing a limited number of embodiments and drawings, those having ordinary skill in the relevant field of art would understand that various modifications and alterations can be derived from the descriptions set forth above. For example, similarly adequate results can be achieved even if the techniques described above are performed in an order different from that disclosed, and/or if the elements of the system, structure, device, circuit, etc., are coupled or combined in a form different from that disclosed or are replaced or substituted by other elements or equivalents. Therefore, various other implementations, various other embodiments, and equivalents of the invention disclosed in the claims are encompassed by the scope of claims set forth below.

What is claimed is:

1. A prediction model generation method performed by a computing device comprising at least one processor, the prediction model generation method comprising:
constructing a training dataset; and
generating a prediction model by training a graph neural network (GNN),
wherein the training dataset includes input data and result data, and
the constructing of the training dataset comprises:
converting a distributed deep learning training code (distributed training (DT) code) to a graph; and
extracting an adjacency matrix and a feature matrix from the graph.

2. The prediction model generation method of claim 1, wherein the result data includes at least one of graphics processing unit (GPU) utilization, GPU memory utilization, network transmission (TX) throughput, network reception (RX) throughput, a burst time of a GPU, a burst time of a GPU memory, a burst time of a network TX, a burst time of a network RX, an idle time of the GPU, an idle time of the GPU memory, an idle time of the network TX, and an idle time of the network RX.

3. The prediction model generation method of claim 1, wherein the GNN is a graph convolutional network (GCN), a graph isomorphism network (GIN), or a graph attention network (GAN).

4. The prediction model generation method of claim 1, wherein the GNN includes a plurality of graph layers, a graph readout layer, and a multilayer perceptron (MLP) layer.

5. The prediction model generation method of claim 4, wherein each of the graph layers includes a gated recurrent unit (GRU).

6. The prediction model generation method of claim 1, further comprising performing transfer learning (TL) on the prediction model after generating the prediction model.

7. The prediction model generation method of claim 6, wherein the performing of the transfer learning is performed using a second training dataset,
the training dataset is a dataset corresponding to a first DT setting,
the second training dataset is a dataset corresponding to a second DT setting, and
the first DT setting and the second DT setting are different in at least one type of GPU that performs distributed deep learning, the number of parameter servers (PSs), and the number of worker nodes.

8. The prediction model generation method of claim 6, wherein the transfer learning updates at least one of parameters of at least some graph layers among a plurality of graph layers included in the prediction model and parameters of an MLP layer included in the prediction model.

9. The prediction model generation method of claim 6, wherein the transfer learning updates parameters of the latter half layers of a plurality of graph layers included in the prediction model and parameters of an MLP layer.

10. A prediction method using a prediction model generated by a prediction model generation method according to claim 1, the prediction method comprising:
generating input data to be predicted; and
performing prediction by inputting the input data to be predicted to the prediction model.
